(19) United States
(12) Patent Application Publication
(10) Pub. No.: US 2019/0084201 A1
(43) Pub. Date: Mar. 21, 2019

(54) MOLDING APPARATUS, MOLDING METHOD, AND MOLDING SYSTEM

(71) Applicant: TOSHIBA KIKAI KABUSHIKI KAISHA, Tokyo (JP)

(72) Inventor: Nobuyuki ASANUMA, Numazu-shi (JP)

(73) Assignee: TOSHIBA KIKAI KABUSHIKI KAISHA, Tokyo (JP)

(21) Appl. No.: 16/193,647

(22) Filed: Nov. 16, 2018

Related U.S. Application Data
(63) Continuation of application No. PCT/JP2017/014587, filed on Apr. 7, 2017.

(30) Foreign Application Priority Data
May 17, 2016 (JP) 2016-098415

(51) Int. Cl. B29C 45/14; B29C 45/27; B29C 45/03

(52) U.S. Cl. CPC B29C 45/14467; B29C 45/14065; B29K 2101/12; B29C 45/03; B29C 45/2708

(57) ABSTRACT

A molding apparatus includes a gate for filling a plasticized raw material into an injection molding space in which two intermediate base materials are set, and one of the intermediate base materials includes a hole portion. The molding apparatus includes a holder unit which is able to position the two intermediate base materials in the injection molding space opposite to each other, and a support mechanism including a pressing surface for making the hole portion adjacent to the gate by pressing the two intermediate base materials positioned in the injection molding space toward a periphery of the gate.

### CROSS-REFERENCE TO RELATED APPLICATIONS

This application is a Continuation Application of PCT Application No. PCT/JP2017/014587, filed Apr. 7, 2017 and based upon and claiming the benefit of priority from prior Japanese Patent Application No. 2016-098415, filed May 17, 2016, the entire contents of all of which are incorporated herein by reference.

### BACKGROUND OF THE INVENTION

### 1. Field of the Invention

The present invention relates to a molding technique using intermediate base materials, for example, thermoplastic prepregs and thermoplastic stampable sheets.

The thermoplastic prepregs represent, for example, sheetlike intermediate base materials prepared by impregnating fabrics of continuous fiber (or nonwoven fabrics of relatively long fiber) with thermoplastic resins. The thermoplastic stampable sheets represent intermediate base materials molded by laying sheets of the thermoplastic prepregs on each other while heating and pressurizing them.

### 2. Description of the Related Art

In recent years, an approach to replacing metallic components with various types of fiber-reinforced resin has been taken in order to improve fuel-efficiency by reducing the weights of vehicles. As fiber-reinforced resins, intermediate base materials, for example, thermoplastic prepregs or thermoplastic stampable sheets are applied. Patent Literature 1 (JP 2014-172279 A) discloses a hybrid molding technique using the intermediate base materials.

In the hybrid molding technique, the intermediate base materials are heated and softened. The softened intermediate base materials are set into molds. In the molds, press molding and injection molding are performed at the same time. Moldings having certain strength and rigidity are thereby produced.

### BRIEF SUMMARY OF THE INVENTION

Incidentally, in the above-described hybrid molding technique, there are cases where moldings are thickened to improve the strength and rigidity of the moldings. Here, as a method of thickening the moldings, for example, a method of thickening the intermediate base materials is assumed. However, in this method, as the intermediate base materials are thickened, the following problem will arise accordingly.

For example, when the thick intermediate base materials are heated and softened, temperatures become uneven in a thickness direction or a heating time is prolonged. Thus, depending on the degree of unevenness of the temperatures or the length of the heating time, it becomes hard to maintain the quality of moldings constantly. As a result, the yield of moldings cannot be maintained constantly.

An object of the present invention is to provide a molding technique capable of improving the strength and rigidity of a molding by thickening the molding while maintaining its quality and yield constantly.

To achieve the above-described object, in the present invention, a molding apparatus comprises a gate for filling a plasticized raw material into an injection molding space in which two intermediate base materials are set, and one of the intermediate base materials comprises a hole portion. The molding apparatus comprises a holder unit which is able to position the two intermediate base materials in the injection molding space opposite to each other, and a support mechanism comprising a pressing surface for making the hole portion adjacent to the gate by pressing the two intermediate base materials positioned in the injection molding space toward a periphery of the gate. The plasticized raw material filled from the gate passes through the hole portion and is formed as an intermediate layer between the two intermediate base materials.

According to the present invention, it is possible to achieve a molding technique capable of improving the strength and rigidity of a molding by thickening the molding while maintaining its quality and yield constantly.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view schematically showing a structure of a molding system in which a molding apparatus is incorporated according to one embodiment.

FIG. 2 is a cross-sectional view of the molding apparatus of FIG. 1.

FIG. 3 is a cross-sectional view showing a state in which intermediate base materials are set into a mold.

FIG. 4 is a cross-sectional view showing a state in which press molding of the intermediate base materials is performed.

FIG. 5 is a cross-sectional view showing a state in which injection molding of the intermediate base materials is started.

FIG. 6 is a cross-sectional view showing a state in which the injection molding of the intermediate base materials is being performed.

FIG. 7 is a cross-sectional view showing a state in which a support member supporting the intermediate base materials is withdrawn as a result of the injection molding.

FIG. 8 is a cross-sectional view of the molding apparatus according to a modification.

FIG. 9 is a cross-sectional view of the molding apparatus according to a modification.

FIG. 10 is a cross-sectional view showing a state in which the injection molding of the intermediate base materials is started in the molding apparatus according to a modification.

FIG. 11 is a cross-sectional view showing a state in which the support member supporting the intermediate base materials is withdrawn as a result of the injection molding in the molding apparatus of FIG. 10.

FIG. 12 is an image view of a sample of the present invention molded by a molding technique of the present invention.

FIG. 13 is an image view of a conventional sample molded by a conventional molding technique.

### DETAILED DESCRIPTION OF THE INVENTION

One of the embodiments of the present invention will be described hereinafter with reference to the accompanying drawings.

### One Embodiment

“Summary of Molding System 1”

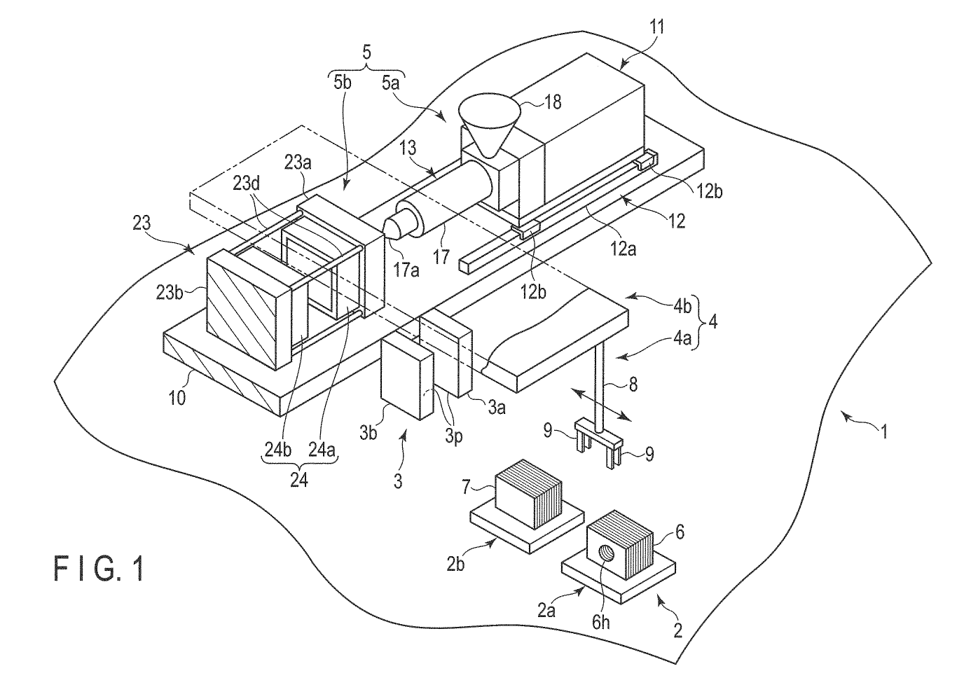

FIG. 1 shows a molding system 1 according to one embodiment. The molding system 1 comprises an accommodation unit 2, a heating apparatus 3, a conveyance apparatus 4, and a molding apparatus 5. The accommodation unit 2 is configured to be able to accommodate a plurality of types of intermediate base materials 6 and 7. The heating apparatus 3 is configured to be able to heat the intermediate base materials 6 and 7. The conveyance apparatus 4 is configured to be able to convey the intermediate base materials 6 and 7 accommodated in the accommodation unit 2 to the molding apparatus 5 via the heating apparatus 3. The molding apparatus 5 is configured to be able to perform hybrid molding of the intermediate base materials 6 and 7.

Here, the intermediate base materials 6 and 7 represent the generic term of the above-described thermoplastic prepregs and thermoplastic stampable sheets, etc. The intermediate base materials 6 and 7 have the shape of sheets. Hybrid molding is a processing method of performing press molding and injection molding of the intermediate base materials 6 and 7 at the same time. In the following description, the molding system 1 will be specifically explained.

“Accommodation Unit 2”

The accommodation unit 2 comprises accommodation portions 2a and 2b. In the figures, the accommodation unit 2 comprises two accommodation portions (first accommodation portion 2a and second accommodation portion 2b) as an example. The two accommodation portions (first accommodation portion 2a and second accommodation portion 2b) are configured to be able to accommodate the intermediate base materials 6 and 7 of different types. For example, intermediate base materials (hereinafter, first intermediate base materials 6) having a hole portion 6h(also referred to as a path portion) are accommodated together in the first accommodation portion 2a. Intermediate base materials (hereinafter, second intermediate base materials 7) having no hole portion (path portion) are accommodated together in the second accommodation portion 2b.

The hole portion (path portion) 6h is formed to penetrate the sheetlike first intermediate base materials 6. In this case, the outline shapes of the intermediate base materials 6 and 7 can be arbitrarily set to, for example, rectangles, circles, ellipses, triangles, or polygons. The figures show the rectangular intermediate base materials 6 and 7 as an example.

Here, the position of the hole portion (path portion) 6h may be set anywhere in the range of the first intermediate base materials 6. In the figures, the hole portion (path portion) 6h is provided in the central portions of the first intermediate base materials 6 as an example. The number of hole portions (path portions) 6h is set correspondingly to the number of gates 29 of a mold 24 (stationary mold 24a or first mold), which will be described later. In the figures, one hole portion (path portion) 6h is provided in the central portions of the first intermediate base materials 6 correspondingly to the one gate 29 provided in the mold 24 (stationary mold 24a or first mold) as an example. The outline (cross-sectional) shape of the hole portion (path portion) 6h can be arbitrarily set to, for example, a rectangle, a circle, an ellipse, a triangle, or a polygon. In the figures, the circular hole portion (path portion) 6h is applied correspondingly to the outline shape of the gate 29 of the mold 24 (stationary mold 24a or first mold) as an example.

The first accommodation portion 2a is configured to be able to accommodate the first intermediate base materials 6 in a vertical position or a horizontal position. The second accommodation portion 2b is configured to be able to accommodate the second intermediate base materials 7 in the vertical position or the horizontal position. The vertical position represents a position in which the intermediate base materials 6 and 7 in the state of standing in a vertical direction are arranged in a horizontal direction. The horizontal position represents a position in which the intermediate base materials 6 and 7 in the state of being laid in a horizontal direction are stacked in a vertical direction. In the figures, the intermediate base materials 6 and 7 are accommodated in the first and second accommodation portions 2a and 2b in the vertical position as an example.

“Heating Apparatus 3”

The heating apparatus 3 comprises heaters 3a and 3b and a controller (not shown in the figures) which controls the heaters 3a and 3b. In the figures, the heating apparatus 3 comprises the two heaters 3a and 3b as an example. The heaters 3a and 3b are provided with heating portions 3p. The two heaters 3a and 3b are placed parallel opposite to each other. In this state, the heating portions 3p are positioned parallel opposite to each other. Moreover, the temperatures of the heating portions 3p can be increased or reduced by the controller. The temperatures and heating times of the heating portions 3p are set, for example, to such an extent that press molding can be performed in the mold 24, which will be described later.

In the above-described structure, the intermediate base materials 6 and 7 conveyed by the conveyance apparatus 4, which will be described later, pass through the space between the two heaters 3a and 3b (heating portions 3p). At this time, the intermediate base materials 6 and 7 are heated and warmed up from both sides by the heating portions 3p. For example, the first and second intermediate base materials 6 and 7 are heated to a temperature close to the melting temperature of a thermoplastic resin, with which they are impregnated, or a temperature higher than the melting temperature. The temperatures of the first and second intermediate base materials 6 and 7 are set higher than the temperatures of molding surfaces (first molding surface 25a and second molding surface 26a) of the mold 24, which will be described later. The intermediate base materials 6 and 7, which have been warmed up in this matter, are conveyed by the conveyance apparatus 4 to the molding apparatus 5, which will be described later.

“Conveyance Apparatus 4”

The conveyance apparatus 4 comprises a crane mechanism 4a, a movement mechanism 4b, and a control mechanism (not shown in the figures). The control mechanism is configured to be able to control the crane mechanism 4a and the movement mechanism 4b. The crane mechanism 4a comprises a movable shaft 8 and a holding mechanism 9. The movable shaft 8 is, for example, controlled to be able to extend or shorten along a vertical direction. A proximal end of the movable shaft 8 is supported by the movement mechanism 4b. The movement mechanism 4b is, for example, controlled to be able to move the movable shaft 8 along a horizontal direction.

The holding mechanism 9 is provided at a distal end of the movable shaft 8. The holding mechanism 9 comprises a plurality of hooks. The holding mechanism (hooks) 9 is controlled to be able to hold the intermediate base materials 6 and 7 at the same time. Here, a configuration where one of the first intermediate base materials 6 and one of the second intermediate base materials 7 are held by the holding mechanism (hooks) 9 at the same time is assumed.

In this configuration, for example, the movable shaft 8 is moved in a horizontal direction. The holding mechanism (hooks) 9 is positioned right above the first accommodation portion 2a (or the second accommodation portion 2b). The movable shaft 8 is extended. The holding mechanism (hooks) 9 thereby can hold the first and second intermediate base materials 6 and 7.

For example, one of the first intermediate base materials 6 is held by the holding mechanism (hooks) 9. Next, the movable shaft 8 is shortened, and then moved in a horizontal direction. The holding mechanism (hooks) 9 is positioned right above the second accommodation portion 2b. The movable shaft 8 is extended. One of the second intermediate base materials 7 is held by the holding mechanism (hooks) 9. In this manner, one of the first intermediate base materials 6 and one of the second intermediate base materials 7 are held by the holding mechanism (hooks) 9. In this case, the first intermediate base material 6 and the second intermediate base material 7 are held parallel opposite to each other.

Then, the movable shaft 8 is shortened. The first and second intermediate base materials 6 and 7 are thereby lifted up in a vertical direction with the holding Mechanism (hooks) 9. In this state, the movable shaft 8 is moved in a horizontal direction. Then, the first and second intermediate base materials 6 and 7 are made to pass through the space between the heaters 3a and 3b (heating portions 3p). At this time, the first and second intermediate base materials 6 and 7 are heated by the heaters 3a and 3b (heating portions 3p), for example, to such an extent that press molding can be performed. In other words, the first and second intermediate base materials 6 and 7 are heated to a temperature close to the melting temperature of a thermoplastic resin, with which they are impregnated, or a temperature higher than the melting temperature. The temperatures of the first and second intermediate base materials 6 and 7 are set higher than the temperatures of the molding surfaces (first molding surface 25a and second molding surface 26a) of the mold 24.

Moreover, the movable shaft 8 is moved in a horizontal direction. The first and second intermediate base materials 6 and 7 are conveyed to the molding apparatus 5. At this time, the first and second intermediate base materials 6 and 7 are transferred from the holding mechanism (hooks) 9 to the molding apparatus 5. In the molding apparatus 5, hybrid molding (molding in which press molding and injection molding are performed at the same time) of the first and second intermediate base materials 6 and 7 is performed.

“Molding Apparatus 5”

As shown in FIG. 1 to FIG. 3, the molding apparatus 5 is provided on a base 10. The molding apparatus 5 comprises an injection unit 5a and a mold clamping unit 5b. In the molding apparatus 5, a plasticized material (melted resin material) injected from the injection unit 5a is cooled and solidified in the mold clamping unit 5b. Various moldings suitable for purposes (uses) thereby can be manufactured.

“Injection Unit 5a”

The injection unit 5a comprises a unit main body 11, a movement mechanism 12, and an injection structure 13. The unit main body 11 is configured to be able to be moved in a preset direction by the movement mechanism 12. The injection structure 13 is coupled to the unit main body 11. The injection structure 13 is thereby configured to be able to move in accordance with the unit main body 11. Further, in the unit main body 11, a rotational movement apparatus 20, which will be described later, is installed.

The movement mechanism 12 comprises two guide rails 12a, sliders 12b, and a driving portion 12c. The two guide rails 12a are placed parallel opposite to each other. The guide rails 12a are placed toward the mold clamping unit 5b, which will be described later. The sliders 12b are configured to be able to move along the guide rails 12a. The sliders 12b are attached to the unit main body 11. The unit main body 11 is thereby configured to be able to move along the guide rails 12a.

The driving portion 12c comprises a motor 14, a ball screw 15, and a nut structure 16. The motor 14 is supported by the base 10. The ball screw 15 is coupled to an output axis (not shown in the figures) of the motor 14. The ball screw 15 is placed parallel to the guide rails 12a. The nut structure 16 is screwed on the ball screw 15. The nut structure 16 is coupled to the above-described unit main body 11.

In the driving portion 12c, the motor 14 is driven. The rotational movement of the motor 14 is transmitted to the ball screw 15 via the output axis and rotates the ball screw 15. Because of the rotation of the ball screw 15, the nut structure 16 moves along the ball screw 15. At this time, the unit main body 11 moves along the guide rails 12a in accordance with the movement of the nut structure 16.

In this manner, the injection structure 13 can be moved toward the mold clamping unit 5b, which will be described later, in accordance with the unit main body 11. A nozzle 17a of the injection structure 13 thereby can be brought into contact with (adhered to) a nozzle touch portion 30 of the mold clamping unit 5b (that is, the mold 24) without a gap. As a result, a plasticized raw material injected from the nozzle 17a of the injection structure 13 does not leak to the outside.

The injection structure 13 comprises a cylinder main body 17 comprising both ends (distal and proximal ends), a hopper 18, and a screw 19. The cylinder main body 17 is provided with a cylinder 17s having a hollow cylindrical shape. The screw 19 is rotatably inserted in the cylinder 17s. The cylinder 17s is continuously formed from the proximal end to the distal end of the cylinder main body 17. The proximal end of the cylinder main body 17 is provided with the hopper 18. The distal end of the cylinder main body 17 is provided with the nozzle 17a.

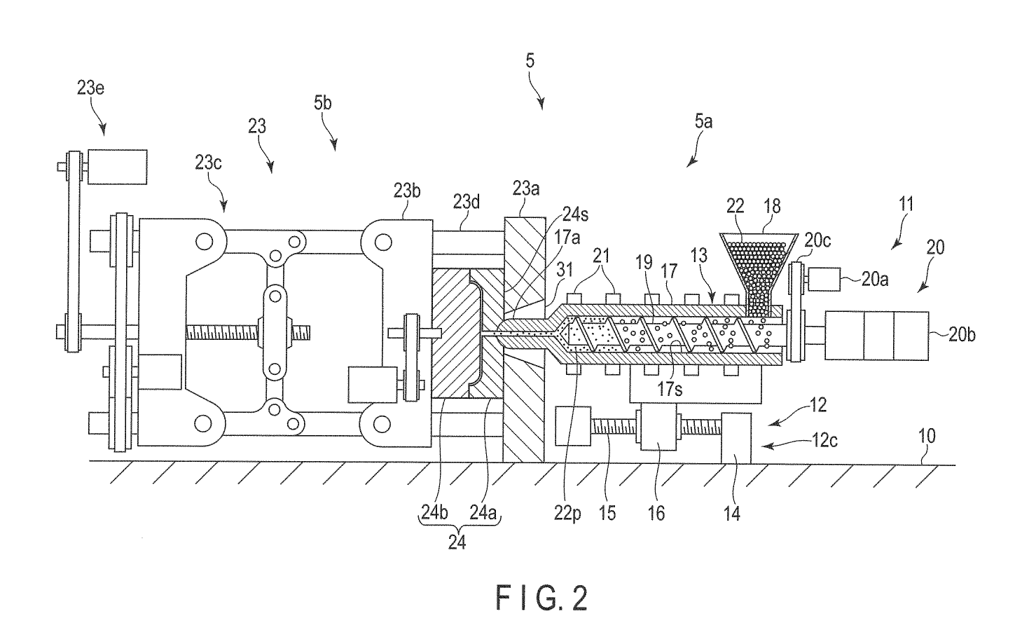

The screw 19 is continuously formed along the cylinder 17s. In a state in which the screw 19 is inserted in the cylinder 17s, the distal end of the screw 19 is positioned opposite to the nozzle 17a. The proximal end of the screw 19 is coupled to the rotational movement apparatus 20 (refer to FIG. 2). The rotational movement apparatus 20 is installed in the unit main body 11.

The rotational movement apparatus 20 comprises, for example, a motor 20a, an actuator 20b, and a timing belt 20c. The actuator 20b is coupled to the proximal end of the screw 19. The actuator 20b is configured to be able to move the screw 19 (forward or backward) along the cylinder 17s. The motor 20a is coupled to the proximal end of the screw 19 via the timing belt 20c.

Here, the motor 20a is driven. The rotational movement of the motor 20a is transmitted to the proximal end of the screw 19 via the timing belt 20c. The screw 19 thereby can be rotated in a preset rotational state (for example, the rate of rotation or angular velocity).

The cylinder main body 17 is provided with a heater 21. The cylinder main body 17 is heated by the heater 21, and the temperature in the cylinder 17s thereby can be adjusted to a preset temperature. As the preset temperature, for example, the optimum temperature for melting a raw material 22 (refer to FIG. 2) fed into the cylinder 17s can be assumed.

“Operation of Injection Unit 5a”

The screw 19 in the cylinder 17s is rotated with its distal end close to the nozzle 17a. Here, the raw material 22 (for example, a resin material in the form of pellets) is supplied to the hopper. The raw material 22 is fed into the cylinder 17s through the hopper 18.

The fed raw material 22 is conveyed toward the distal end (nozzle 17a) of the cylinder 17s by the rotating screw 19. Meanwhile, the raw material 22 is heated by the heater 21 while being compressed. The melted raw material 22 (plasticized raw material 22p) is thereby produced. In this manner, the plasticized raw material 22p is conveyed to the distal end of the screw 19.

At this time, the screw 19 moves backward, being pushed by the plasticized raw material 22p conveyed to the distal end of the screw 19. Then, the screw 19 moves backward to a measurement completion position. At this time, the rotation of the screw 19 is stopped. In this manner, the plasticized raw material 22p necessary to mold one molding is stored in the cylinder 17s (that is, in the cylinder 17s between the distal end of the screw 19 and the nozzle 17a).

Next, the screw 19 in a nonrotational state is moved forward toward the nozzle 17a. At this time, pressure force is applied on the plasticized raw material 22p from the distal end of the screw 19. The plasticized raw material 22p thereby can be injected from the nozzle 17a to the outside of the cylinder 17s (for example, the mold 24 of the mold clamping unit 5b, which will be described later). Then, for example, the mold 24 is cooled. The plasticized raw material 22p is cooled and solidified. Various moldings suitable for purposes (uses) are thereby molded. In this manner, a finished molding can be obtained by being removed from the mold 24.

“Mold Clamping Unit 5b”

The mold clamping unit 5b comprises a mold clamping apparatus 23 and the mold 24. The mold clamping apparatus 23 is configured to be able to clamp the mold 24 in a lateral direction (for example, a horizontal direction). Here, a toggle mechanism is applied as an example of a mold clamping mechanism 23c, which will be described later.

The mold clamping apparatus 23 comprises a stationary platen 23a, a movable platen 23b, the mold clamping mechanism 23c, tie-bars 23d, and a driving portion 23e. The stationary platen 23a is fixed on the base 10. The movable platen 23b is supported by the mold clamping mechanism 23c. The tie-bars 23d are placed to extend between the mold clamping mechanism 23c and the stationary platen 23a. The movable platen 23b is configured to be able to move forward or backward along the tie-bars 23d. The driving portion 23e is configured to control the forward and backward movements of the movable platen 23b made by the mold clamping mechanism 23c.

The mold 24 comprises the stationary mold (first mold) 24a and the movable mold (second mold) 24b. The stationary mold 24a is supported by the stationary platen 23a of the mold clamping apparatus 23. The movable mold 24b is supported by the movable platen 23b of the mold clamping apparatus 23. The stationary mold 24a and the movable mold 24b are thereby configured to be able to open or close in a lateral direction (horizontal direction).

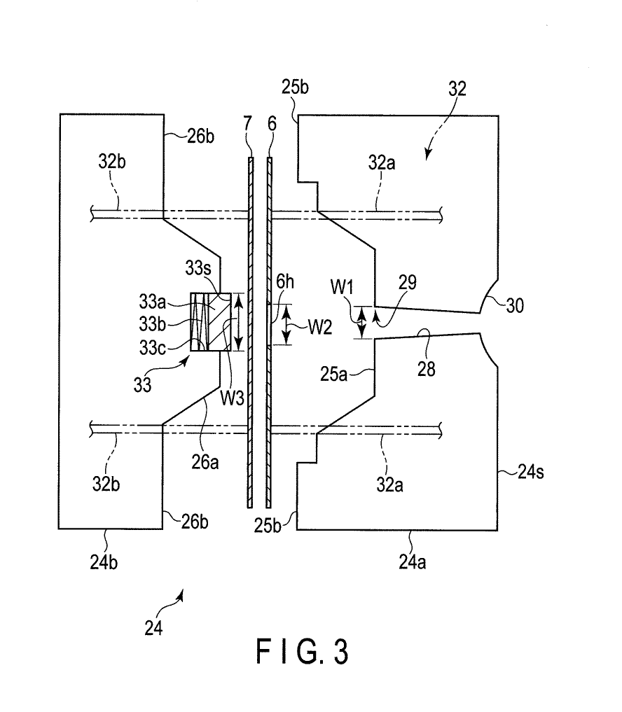

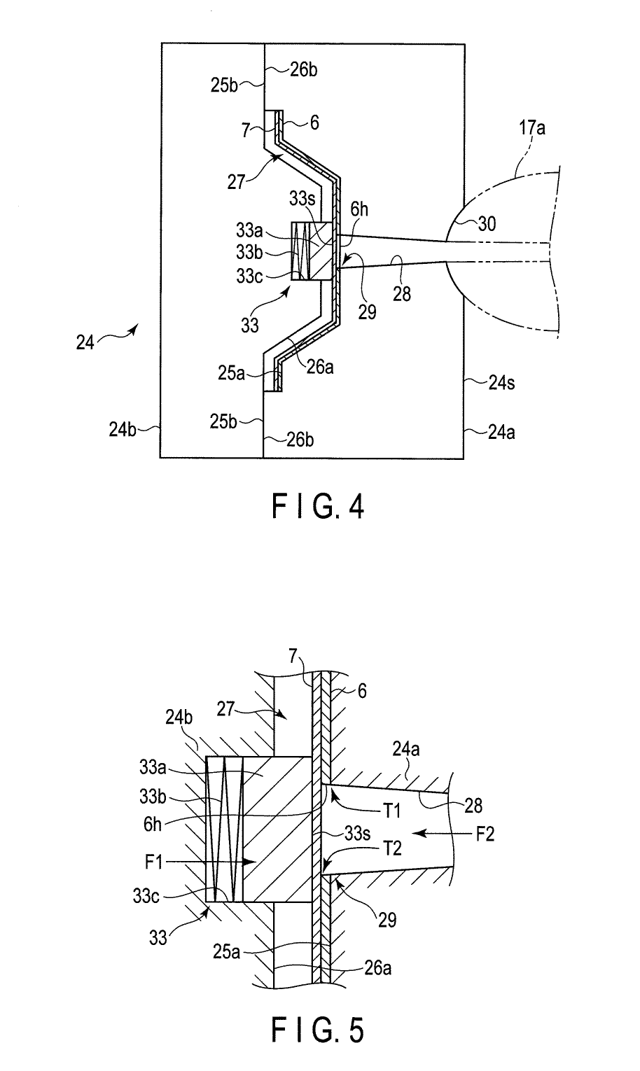

In the above-described structure, the driving portion 23e is controlled by a controller not shown in the figures, and the movable platen 23b is moved backward. The movable mold 24b is separated from the stationary mold 24a. The mold 24 thereby can be kept in an opened state (refer to FIG. 3). In contrast, the mold clamping mechanism 23c is controlled by the controller, and the movable platen 23b is moved forward. The movable mold 24b is brought close to the stationary mold 24a. Then, a first parting surface 25b and a second parting surface 26b, which will be described later, are brought into contact with (adhered to) each other. The mold 24 thereby can be kept in a closed state (that is, a clamped state) (refer to FIG. 4).

In addition, the stationary mold (first mold) 24a comprises the first molding surface 25a and the first parting surface 25b. The movable mold (second mold) 24b comprises the second molding surface 26a and the second parting surface 26b. In this case, in a state in which the mold 24 (stationary mold 24a and movable mold 24b) is clamped in a lateral direction (horizontal direction) (refer to FIG. 4), the first parting surface 25b and the second parting surface 26b contact (adhere to) each other without a gap. In this clamped state, one injection molding space (injection molding region) 27 is formed in a spatial region surrounded by the first molding surface 25a and the second molding surface 26a.

Moreover, the mold 24 (mold clamping unit 5b) comprises a filling mechanism. The filling mechanism is configured to be able to fill the plasticized material 22p (melted resin material) into the injection molding space (injection molding region) 27. Here, the filling mechanism is provided in the stationary mold (first mold) 24a as an example. The filling mechanism (stationary mold 24a) comprises an injection channel 28, the gate 29, and the nozzle touch portion 30. Although not particularly shown in the figures, the injection channel 28 includes a sprue and a runner.

The gate 29 is formed along the first molding surface 25a of the stationary mold 24a. That is, the gate 29 is formed adjacent to the first molding surface 25a. The nozzle touch portion 30 comprises an outline shape along the distal end portion of the above-described injection structure 13 (nozzle 17a). The nozzle touch portion 30 is formed on an attachment surface 24s of the stationary mold 24a. The attachment surface 24s is formed at a portion opposite to the first molding surface 25a on the opposite side.

The injection channel 28 is formed to penetrate the stationary mold 24a from the first molding surface 25a to the attachment surface 24s. That is, the injection channel 28 is configured to allow the gate 29 and the nozzle touch portion 30 to communicate with each other. Thus, the plasticized material 22p (melted resin material) injected from the injection structure 13 (nozzle 17a) can be filled into the above-described injection molding space (injection molding region) 27 via the injection channel 28.

Incidentally, the stationary mold 24a is supported by the stationary platen 23a by fixing the above-described attachment surface 24s on the stationary platen 23a of the mold clamping apparatus 23. Thus, an opening portion 31 is formed in the stationary platen 23a. The opening portion 31 is formed to penetrate the stationary platen 23a. The opening portion 31 is placed opposite to the above-described nozzle touch portion 30. The nozzle touch portion 30 is thereby exposed to the outside through the opening portion 31. As a result, the distal end portion of the injection structure 13 (nozzle 17a) can be smoothly and safely brought into contact with (adhered to) the nozzle touch portion 30 (refer to FIG. 2 and FIG. 4).

“Main Molding Technique (Holder Unit 32 and Support Mechanism 33)”

“Holder Unit 32”

The molding apparatus 5 (specifically, the mold 24) comprises a holder unit 32. The holder unit 32 is configured to be able to receive and hold the first and second intermediate base materials 6 and 7 conveyed by the above-described conveyance apparatus 4.

The holder unit 32 is configured to be able to hold the first intermediate base material 6 and the second intermediate base material 7 in the mold 24 while making them parallel opposite to (adjacent to) each other in a state in which the mold 24 is opened (refer to FIG. 3). That is, the holder unit 32 is configured to be able to position the first intermediate base material 6 and the second intermediate base material 7, which are placed parallel opposite to (adjacent to) each other, between the stationary mold (first mold) 24a and the movable mold (second mold) 24b. In other words, the holder unit 32 is configured to be able to hold the first intermediate base material 6 and the second intermediate base material 7, which are placed opposite to (adjacent to) each other, in the mold 24, such that the hole portion (path portion) 6h of the first intermediate base material 6 is placed opposite to the gate 29.

The holder unit 32 comprises first holders 32a. The first holders 32a are provided in the stationary mold (first mold) 24a. The first holders 32a are configured to be freely projected or depressed from the first molding surface 25a. The first holders 32a are configured to be able to hold the first intermediate base material 6.

The holder unit 32 comprises second holders 32b. The second holders 32b are provided in the movable mold (second mold) 24b. The second holders 32b are configured to be freely projected or depressed from the second molding surface 26a. The second holders 32b are configured to be able to hold the second intermediate base material 7.

Here, as a holding method, it is possible to apply an existent method, for example, a method of holding the first and second intermediate base materials 6 and 7 by adhering them to the first and second holders 32a and 32b, a method of holding the first and second intermediate base materials 6 and 7 by hanging them on the first and second holders 32a and 32b, or a method of holding the first and second intermediate base materials 6 and 7 by making them sandwiched between the first holders 32a and the second holders 32b.

According to the above-described structure, in a state in which the mold 24 is opened (refer to FIG. 3), the first and second holders 32a and 32b are projected toward the space between the stationary mold (first mold) 24a and the movable mold (second mold) 24b. The first and second intermediate base materials 6 and 7 are thereby held in the mold 24. Then, the first and second holders 32a and 32b are withdrawn in synchrony with the timing of bringing the movable mold 24b close to the stationary mold 24a by the above-described mold clamping mechanism 23c.

Then, in a state in which the mold 24 is closed (refer to FIG. 4), the first and second holders 32a and 32b are stored in the insides of the stationary mold (first mold) 24a and the movable mold (second mold) 24b. At this time, the first and second holders 32a and 32b are stored in positions except the injection molding space (injection molding region) 27. In this manner, the first and second intermediate base materials 6 and 7 are set into the injection molding space (injection molding region) 27 of the mold 24. At the same time, press molding of the first and second intermediate base materials 6 and 7 is performed by the first and second molding surfaces 25a and 26a.

“Support Mechanism 33”

The molding apparatus 5 (specifically, the mold 24) further comprises the support mechanism 33. The support mechanism 33 is configured to be able to make the hole portion (path portion) 6h adjacent to the gate 29 by pressing the first and second intermediate base materials 6 and 7, which are set in the injection molding space (injection molding region) 27 of the mold 24, toward the first molding surface 25a around the gate 29 in a state in which the mold 24 is closed (refer to FIG. 4).

The support mechanism 33, for example, comprises a support member 33a, a spring structure 33b, and a guide depression 33c.

The support member 33a comprises a flat pressing surface 33s. The outline shape of the pressing surface 33s can be arbitrarily set to, for example, a rectangle, a circle, an ellipse, a triangle, or a polygon. In the figures, the support member 33a comprising the circular pressing surface 33s is applied correspondingly to the outline shape of the gate 29 as an example. The pressing surface 33s is not limited to a flat surface, but may be, for example, a curved or rough surface in conformity with the shape of a molding or the shape of the second molding surface 26a.

Here, the size (for example, the diameter or surface area) of the pressing surface 33s is set greater than the size (for example, the diameter or opening area) of the hole portion (path portion) 6h and the size (for example, the diameter or opening area) of the gate 29. In this case, the size (for example, the diameter or opening area) of the hole portion (path portion) 6h may be set greater than the size (for example, the diameter or opening area) of the gate 29. Alternatively, they may be set to the same size.

That is, the sizes are set to satisfy W1≤W2<W3, where W1 is the size of the gate 29, W2 is the size of the hole portion (path portion) 6h, and W3 is the size of the pressing surface 33s (refer to FIG. 3).

As the spring structure 33b, for example, a compression coil spring or a spring can be applied. In this case, the spring force (elastic force or pressure force) of the spring structure 33b is set smaller than the flow pressure of the plasticized raw material 22p flowing through the gate 29 in a state in which the plasticized raw material 22p is filled into the injection molding space (injection molding region) 27 by the above-described filling mechanism (28, 29, and 30).

That is, the spring force and the flow pressure are set to satisfy F1<F2, where F1 is the spring force (elastic force or pressure force) of the spring structure 33b, and F2 is the flow pressure of the plasticized raw material 22p flowing through the gate 29. F1 is defined as a pressure applied on the first and second intermediate base materials 6 and 7 from the above-described pressing surface 33s.

The guide depression 33c is formed by depressing a part of the second molding surface 26a (mold 24 or movable mold 24b). In the figures, the guide depression 33c is provided in a part of the second molding surface 26a, which is opposite to the gate 29, as an example. The guide depression 33c has a size which allows the support member 33a and the spring structure 33b to be stored. The support member 33a (pressing surface 33s) is thereby positioned in a position in which it is parallel opposite to the gate 29 at all times.

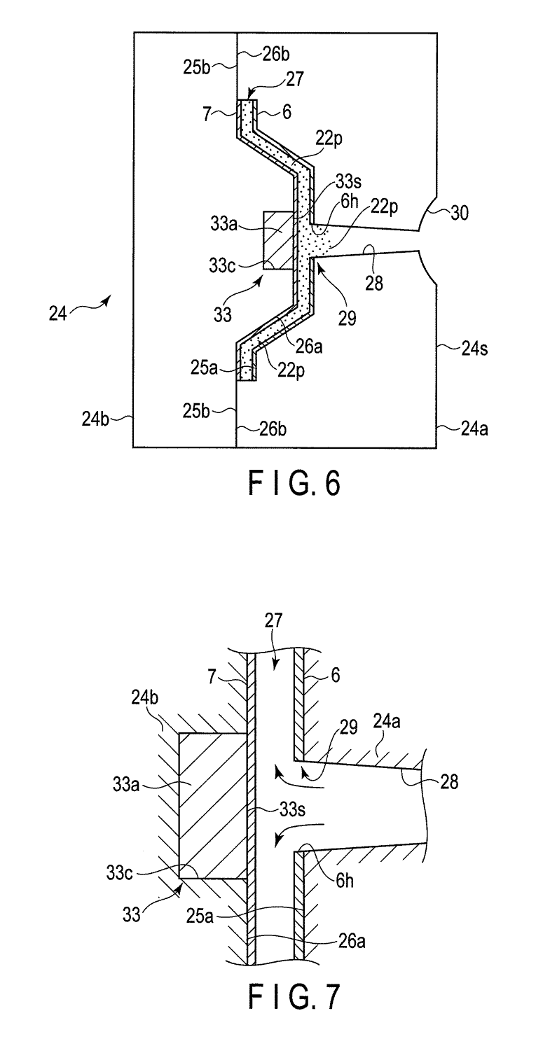

Here, the support member 33a is pushed into the guide depression 33c against the elastic force of the spring structure 33b. The pressing surface 33s of the support member 33a is thereby positioned on the same plane as the second molding surface 26a (refer to FIG. 6). On the other hand, the pushing force is released. A part of the support member 33a is projected from the guide depression 33c (that is, the second molding surface 26a) by the elastic force of the spring structure 33b. The pressing surface 33s is thereby positioned to be projected toward the gate 29 (refer to FIG. 3).

“Action of Main Molding Technique (Holder Unit 32 and Support Mechanism 33)”

As shown in FIG. 4 to FIG. 7, in the molding technique of the present embodiment, the first and second intermediate base materials 6 and 7 are set into the injection molding space (injection molding region) 27 of the mold 24 by the holder unit 32 (first holders 32a and second holders 32b). At this time, the mold 24 is set in a closed state (refer to FIG. 4 and FIG. 5).

In this state, the first and second intermediate base materials 6 and 7 are pressed toward the first molding surface 25a around the gate 29 by the pressing surface 33s of the support member 33a projecting from the second molding surface 26a. At this time, the spring force (elastic force or pressure force) of the spring structure 33b is applied on the first and second intermediate base materials 6 and 7 from the pressing surface 33s.

The first and second intermediate base materials 6 and 7 thereby contact (adhere to) the first molding surface 25a around the gate 29 without a gap. At this time, the hole portion (path portion) 6h of the first intermediate base material 6 is positioned adjacent to the gate 29. In other words, the hole portion (path portion) 6h and the gate 29 are aligned with each other, and are placed opposite to each other while keeping adjacent to each other.

Here, the plasticized raw material 22p is filled into the injection molding space (injection molding region) 27 by the filling mechanism (28, 29, and 30). At this time, the plasticized raw material 22p flowing through the gate 29 is likely to flow toward the gap between the first intermediate base material 6 and the first molding surface 25a in an arrow direction T1 (refer to FIG. 5).

Incidentally, the first intermediate base material 6 contacts (adheres to) the first molding surface 25a because of the pressure force from the pressing surface 33s. Thus, heat of the plasticized raw material 22p, which is likely to flow into the gap between the intermediate base material 6 and the first molding surface 25a, is taken away by the first molding surface 25a. The plasticized raw material 22p, which is likely to flow into the gap, is thereby cooled in a short time, and set in the state of having high viscosity and low flowability, or a solidified state. As a result, it becomes hard for the plasticized raw material 22p to flow into the gap.

On the other hand, the plasticized raw material 22p flowing through the gap 29 is likely to flow toward the gap between the first intermediate base material 6 and the second intermediate base material 7, which is exposed through the hole portion (path portion) 6h, in an arrow direction T2 (refer to FIG. 5) at the same time it is likely to flow into the gap between the first intermediate base material 6 and the first molding surface 25a.

Contact surfaces of the first intermediate base material 6 and the second intermediate base material 7 are away from the first molding surface 25a and the pressing surface 33s at a distance corresponding to the thicknesses of the respective intermediate base materials 6 and 7. Thus, the temperatures of the contact surfaces do not decline in a short time, even if the pressure force is applied from the pressing surface 33s. Accordingly, it becomes easy for the plasticized raw material 22p to flow into the gap between the contact surfaces.

Therefore, the plasticized raw material 22p flowing through the gate 29 does not flow into the gap between the first intermediate base material 6 and the first molding surface 25a, but flows into the gap between the first intermediate base material 6 and the second intermediate base material 7. At this time, since heat of the plasticized raw material 22p is not taken away, the plasticized raw material 22p flows into the gap uninterruptedly.

Then, the flow of the plasticized raw material 22p flowing into the gap increases. In due course, the flow pressure F2 of the plasticized raw material 22p exceeds the spring force (elastic force or pressure force) F1 of the spring structure 33b. Then, because of the flow pressure F2, the support member 33a is pushed into the guide depression 33c against the elastic pressure of the spring structure 33b. The contact surfaces of the first intermediate base material 6 and the second intermediate base material 7 are thereby separated sequentially, and the channel of the plasticized raw material 22p, in other words, the injection molding space (injection molding region) 27, is formed (refer to FIG. 7). In this manner, the pressing surface 33s of the support member 33a is positioned on the same plane as the second molding surface 26a (refer to FIG. 6).

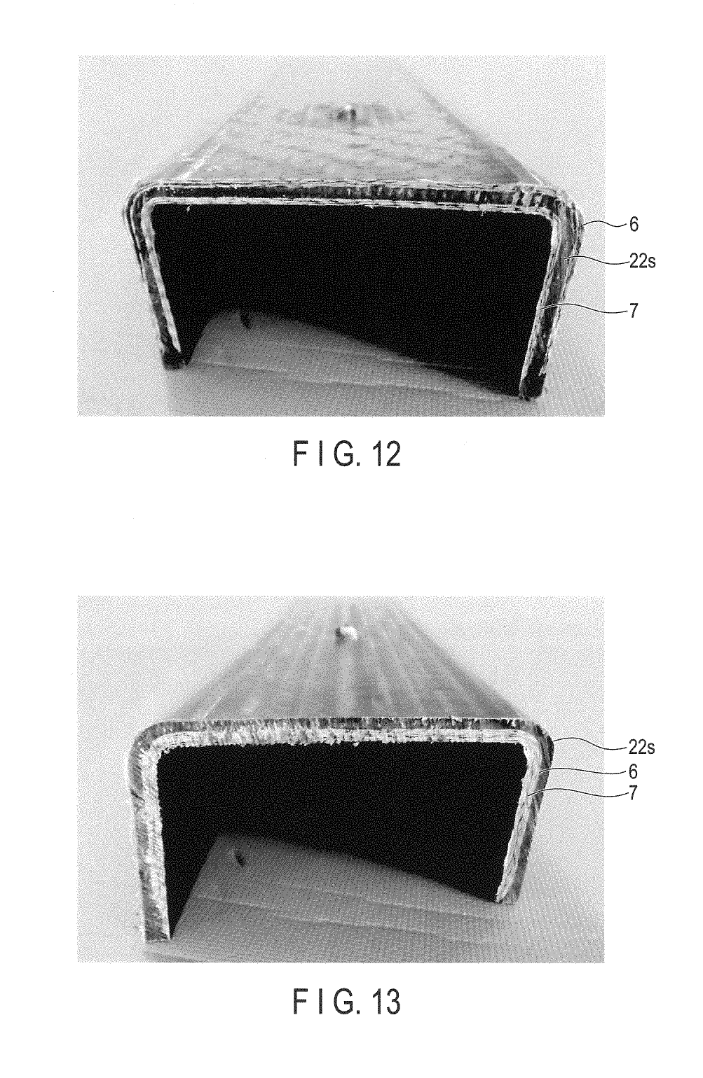

Then, the plasticized material 22p is cooled and solidified. Various moldings suitable for purposes (uses) are thereby molded. For example, a molding with an injection layer 22s formed between the two intermediate base materials 6 and 7 can be formed (refer to FIG. 12). In this manner, a finished molding can be obtained by being removed from the mold 24.

“Advantages of One Embodiment”

According to the present embodiment, the first and second intermediate base materials 6 and 7, which are set in the injection molding space (injection molding region) 27 of the mold 24, are pressed toward the first molding surface 25a around the gate 29 by the support mechanism 33. The hole portion (path portion) 6h is thereby made adjacent to the gate 29. In this state, the plasticized raw material 22p is filled into the injection molding space (injection molding region) 27. Moreover, the sizes are set to satisfy W1≤W2<W3, where W1 is the size of the gate 29, W2 is the size of the hole portion (path portion) 6h, and W3 is the size of the pressing surface 33s. Moreover, the spring force and the flow pressure are set to satisfy F1<F2, where F1 is the spring force (elastic force or pressure force) of the spring structure 33b, and F2 is the flow pressure of the plasticized raw material 22p flowing through the gate 29.

The molding with the injection layer 22s (refer to FIG. 12) formed between the two intermediate base materials 6 and 7 thereby can be formed. In this case, the injection layer 22s is sandwiched between the thin intermediate base materials 6 and 7. By virtue of this structure, the strength and the rigidity of a finished product can be improved while maintaining its quality and yield constantly.

“Demonstrative Data of Advantages of One Embodiment”

According to the molding technique of the above-described present embodiment, the molding with the injection layer 22s formed between the two intermediate base materials 6 and 7 can be formed as shown in FIG. 12. In contrast, in a configuration where a hole portion (path portion) is formed in one of the two intermediate base materials 6 and 7, but the support mechanism 33 according to the present embodiment is not adopted, a molding with the two intermediate base materials 6 and 7 and the injection layer 22s separated into different regions is obtained as shown in FIG. 13. In the molding of FIG. 13, the quality and yield of a finished product cannot be maintained constantly, and further, its strength and rigidity cannot be improved.

“First Modification”

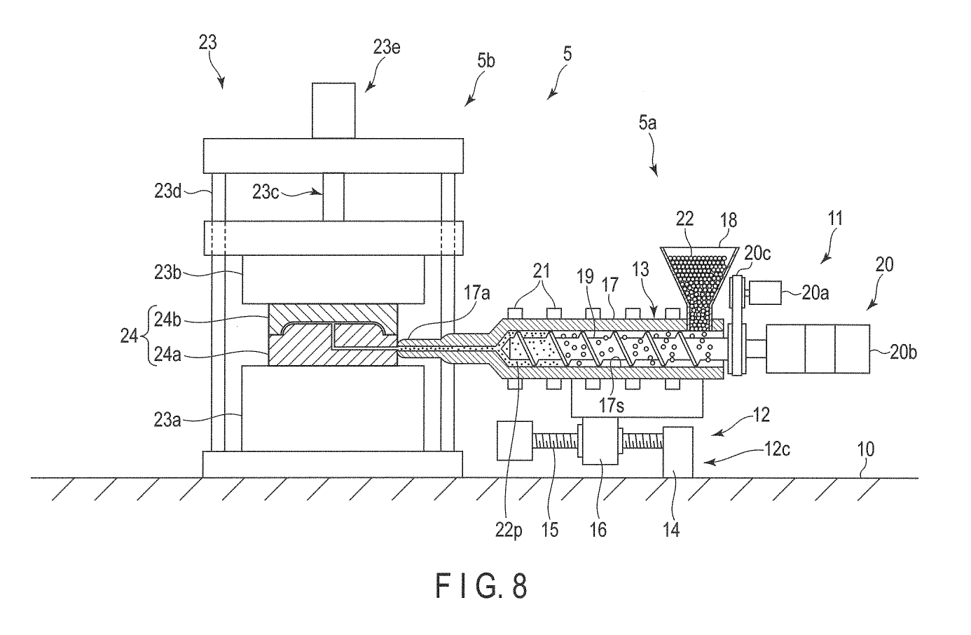

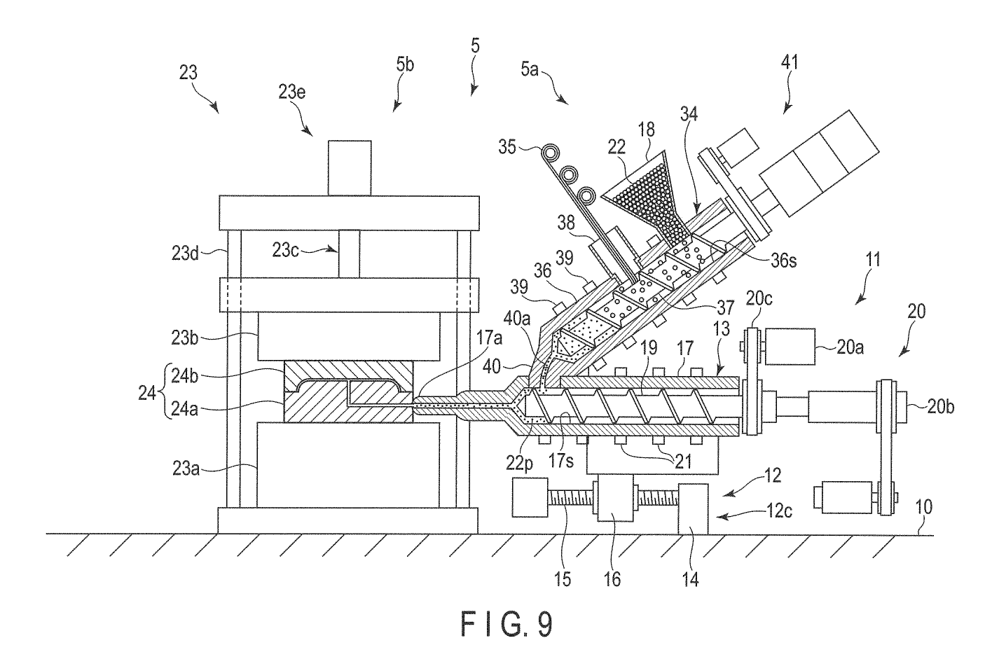

In the above-described embodiment, the mold clamping unit 5b comprising the mold clamping apparatus 23 (mold clamping mechanism 23c) which is able to clamp the mold 24 in a lateral direction (horizontal direction) has been assumed. Instead, the mold clamping unit 5b comprising the mold clamping apparatus 23 (mold clamping mechanism 23c) which is able to clamp the mold 24 in a longitudinal direction (for example, a vertical direction) may be adopted, for example, as shown in FIG. 8. The other structures and advantageous effects of the present modification are the same as those of the above-described embodiment, and thus, an explanation thereof is omitted.

“Second Modification”

The present modification is an improvement of the above-described first modification. Here, an on-line blending function is added to the injection unit 5a. The other structures and advantageous effects are the same as those of the above-described first modification. The on-line blending function will be described hereinafter.

The injection unit 5a comprises the above-described injection structure 13 and an on-line blending structure 34. The on-line blending structure 34 is configured to be able to blend long continuous fiber 35 and the raw material 22 together. The on-line blending structure 34 comprises a second cylinder main body 36, a second screw 37, and a continuous-fiber supply portion 38.

The second cylinder main body 36 is provided with a second cylinder 36s having a hollow cylindrical shape. The second screw 37 is rotatably inserted in the second cylinder 36s. The second cylinder 36s is continuously formed from the proximal end to the distal end of the second cylinder main body 36. The proximal end of the second cylinder main body 36 is provided with the hopper 18. The second cylinder main body 36 is provided with a heater 39.

The temperature in the second cylinder 36s can be adjusted to a preset temperature by heating the second cylinder main body 36 by the heater 39. As the preset temperature, for example, the optimum temperature for melting and blending the raw material 22 fed into the second cylinder 36s and the continuous fiber 35 cut in the second cylinder 36s can be assumed.

The distal end of the second cylinder main body 36 is coupled to the cylinder main body 17. For example, the distal end of the second cylinder main body 36 and the cylinder main body 17 are coupled to each other via a coupling portion 40. The coupling portion 40 is provided with a coupling path 40a. Thus, the second cylinder 36s is connected to communicate with the cylinder 17s via the coupling path 40a.

The second screw 37 is continuously formed along the second cylinder 36s. In a state in which the second screw 37 is inserted in the second cylinder 36s, the distal end of the second screw 37 is positioned opposite to the coupling portion 40. The proximal end of the second screw 37 is coupled to a driving mechanism 41. The driving mechanism 41 is configured to be able to control the rotational state (for example, the rate of rotation or angular velocity) of the second screw 37.

Here, the continuous-fiber supply portion 38 is provided downstream of the hopper 18 in the conveyance direction of the raw material 22. The continuous fiber 35 supplied from the continuous-fiber supply portion 38 to the second cylinder 36s is cut by the rotating second screw 37. The continuous fiber 35, which has been cut, is blended with the raw material 22 because of the rotation of the second screw 37. Moreover, the continuous fiber 35 and the raw material 22 are mutually plasticized and blended by being heated by the heater 39. In this manner, the injection structure 13 can inject the blended material into the mold 24 with a preset timing.

As described above, according to the present modification, the plasticized raw material 22p containing reinforced fiber can be molded. The strength of a molding thereby can be improved. In this case, the cost required for molding can be reduced as compared to that in a configuration where pellets containing reinforced fiber in advance are adopted as the raw material 22. The on-line blending structure 34 can be applied to, not only the above-described one embodiment and first modification, but also a third modification, which will be described later. That is, needless to say, the on-line blending function also can be applied to the injection unit 5a of the molding system of the above-described one embodiment. In addition, the injection unit 5a may be, for example, a plunger injection unit (refer to JP 2015-93432 A).

“Third Modification”

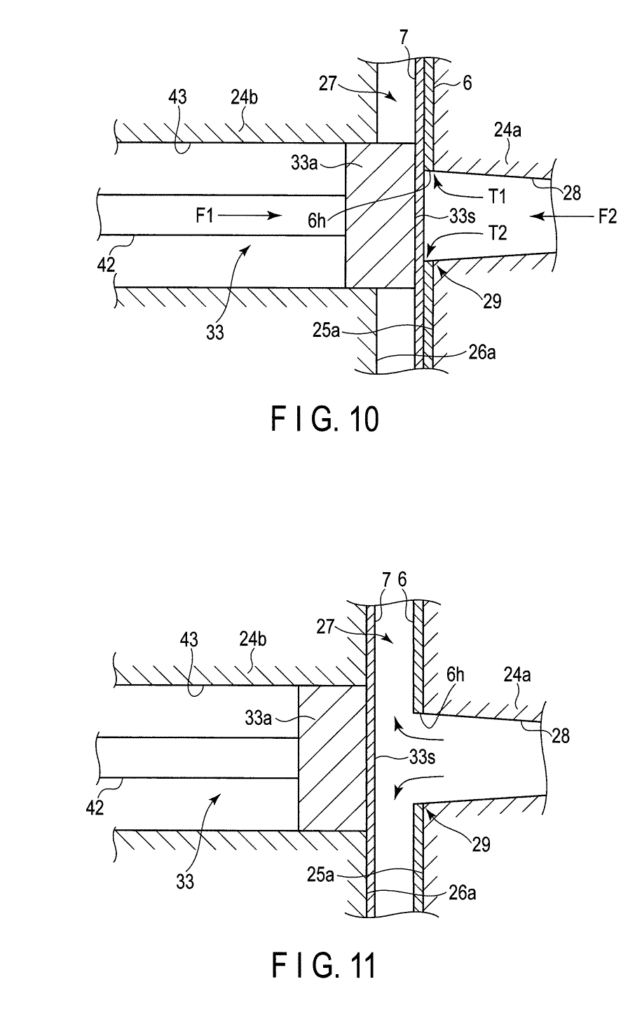

In the above-described embodiment and first and second modifications, the support mechanism 33 comprising the support member 33a, the spring structure 33b, and the guide depression 33c has been assumed. Instead, the support mechanism 33 comprising the support member 33a, a piston 42, and a cylinder 43 may be applied, for example, as shown in FIG. 10 and FIG. 11.

In the support mechanism 33 according to the present modification, the cylinder 43 is formed to penetrate the movable mold (second mold) 24b. The piston 42 is inserted in the cylinder 43 to be able to move (forward or backward). The support member 33a is attached to the distal end of the piston 42. The proximal end of the piston 42 is coupled to a driving mechanism not shown in the figures.

In this structure, the piston 42 is moved forward by the driving mechanism. The support member 33a thereby can be brought close to the gate 29. In contrast, the piston 42 is moved backward by the driving mechanism. The support member 33a thereby can be separated from the gate 29.

Here, the timing of the (forward or backward) movement of the piston 42 can be stored in advance in a memory (not shown in the figures) contained in the driving mechanism. For example, a pressure sensor (not shown in the figures) is installed in the driving mechanism. The pressure sensor is configured to be able to detect a pressure applied on the support member 33a (pressing surface 33s). As the pressure, for example, the flow pressure F2 of the plasticized raw material 22p flowing through the gate 29 can be assumed.

In the present modification, the first and second intermediate base materials 6 and 7 are set into the injection molding space (injection molding region) 27 of the mold 24. The piston 42 is moved forward. The support member 33a is brought close to the gate 29. The first and second intermediate base materials 6 and 7 are thereby pressed toward the first molding surface 25a around the gate 29 by the pressing surface 33s of the support member 33a. The pressure force applied this time is provisionally referred to as F1 (refer to FIG. 10).

Here, the plasticized raw material 22p is filled into the injection molding space (injection molding region) 27 by the filling mechanism (28, 29, and 30). The plasticized raw material 22p flowing through the gate 29 is likely to flow in the arrow directions T1 and T2. In this case, the plasticized raw material 22p, which is likely to flow in the arrow direction T1, is cooled. Thus, it is hard for the plasticized raw material 22p to flow in the same direction.

A flow in the arrow direction T2 continues uninterruptedly and smoothly, because its temperature does not decline in a short time and the flow is facilitated. Then, the flow of the plasticized raw material 22p in the arrow direction T2 increases. In due course, the flow pressure F2 of the plasticized raw material 22p exceeds the pressure force F1 of the piston 42. At this time, the piston 42 is moved backward based on the output of the pressure sensor.

The plasticized raw material 22p thereby flows into the gap between the first intermediate base material 6 and the second intermediate base material 7. At this time, the piston 42 is further moved backward. Then, the pressing surface 33s of the support member 33a is positioned on the same plane as the second molding surface 26a (refer to FIG. 11). In this manner, a molding with the injection layer 22s formed between the two intermediate base materials 6 and 7 is formed (refer to FIG. 12).

The other structures and advantageous effects are the same as those of the above-described embodiment, and thus an explanation thereof is omitted.

“Fourth Modification”

In the above-described embodiment and first to third modifications, the configuration where the first intermediate base material 6 and the second intermediate base material 7 are placed parallel opposite to each other has been assumed. Here, for example, depending on the shape or characteristic (feature) of each of the intermediate base materials 6 and 7, a configuration where they are not parallel opposite to each other, or a configuration where they cannot be parallel opposite to each other is also assumed.

However, needless to say, even in these configurations, the same advantageous effects as those of the above-described embodiment and first to third modifications can be achieved. In this case, for example, in a state in which the first intermediate base material 6 and the second intermediate base material 7 are held by the above-described holder unit 32, the first intermediate base material 6 and the second intermediate base material 7 are configured to be placed, for example, in a direction in which they traverse each other or a direction in which they cross each other.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A molding apparatus comprising a gate for filling a plasticized raw material into an injection molding space in which two intermediate base materials are set, one of the intermediate base materials comprising a hole portion, the molding apparatus comprising:
a holder unit which is able to position the two intermediate base materials in the injection molding space opposite to each other; and
a support mechanism comprising a pressing surface for making the hole portion adjacent to the gate by pressing the two intermediate base materials positioned in the injection molding space toward a periphery of the gate,
wherein the plasticized raw material filled from the gate passes through the hole portion and is formed as an intermediate layer between the two intermediate base materials.

2. The molding apparatus of claim 1, wherein a size of the gate, a size of the hole portion, and a size of the pressing surface are set to satisfy W1≤W2<W3,
where W1 is the size of the gate, W2 is the size of the hole portion, and W3 is the size of the pressing surface.

3. The molding apparatus of claim 1, wherein a pressure applied on the two intermediate base materials from the pressing surface and a flow pressure of the plasticized raw material, which flows through the gate when the plasticized raw material is filled into the injection molding space, are set to satisfy F1<F2,
where F1 is the pressure applied on the two intermediate base materials, and F2 is the flow pressure of the plasticized raw material.

4. A molding method using a molding apparatus comprising a gate for filling a plasticized raw material into an injection molding space in which two intermediate base materials are set, one of the intermediate base materials comprising a hole portion, the molding method comprising:
positioning the two intermediate base materials in the injection molding space opposite to each other; and
making the hole portion adjacent to the gate by pressing the two intermediate base materials positioned in the injection molding space toward a periphery of the gate by a pressing surface,
wherein the plasticized raw material filled from the gate passes through the hole portion and is formed as an intermediate layer between the two intermediate base materials.

5. The molding method of claim 4, wherein a size of the gate, a size of the hole portion, and a size of the pressing surface are set to satisfy W1≤W2<W3,
where W1 is the size of the gate, W2 is the size of the hole portion, and W3 is the size of the pressing surface.

6. The molding method of claim 4, wherein a pressure applied on the two intermediate base materials from the pressing surface and a flow pressure of the plasticized raw material, which flows through the gate when the plasticized raw material is filled into the injection molding space, are set to satisfy F1<F2,
where F1 is the pressure applied on the two intermediate base materials, and F2 is the flow pressure of the plasticized raw material.

7. A molding system comprising:
an accommodation unit which is able to accommodate a plurality of types of intermediate base materials including an intermediate base material comprising a hole portion;
a heating apparatus heating the intermediate base materials;
a molding apparatus comprising a gate for filling a plasticized raw material into an injection molding space in which two of the intermediate base materials are set, one of the intermediate base materials comprising a hole portion; and
a conveyance apparatus which is able to convey the intermediate base materials accommodated in the accommodation unit to the molding apparatus via the heating apparatus,
wherein the molding apparatus comprises:
a holder unit which is able to position the two intermediate base materials in the injection molding space opposite to each other; and
a support mechanism comprising a pressing surface for making the hole portion adjacent to the gate by pressing the two intermediate base materials positioned in the injection molding space toward a periphery of the gate, and
the plasticized raw material filled from the gate passes through the hole portion and is formed as an intermediate layer between the two intermediate base materials.

8. The molding system of claim 7, wherein a size of the gate, a size of the hole portion, and a size of the pressing surface are set to satisfy W1≤W2<W3,
where W1 is the size of the gate, W2 is the size of the hole portion, and W3 is the size of the pressing surface.

9. The molding system of claim 7, wherein a pressure applied on the two intermediate base materials from the pressing surface and a flow pressure of the plasticized raw material, which flows through the gate when the plasticized raw material is filled into the injection molding space, are set to satisfy F1<F2,
where F1 is the pressure applied on the two intermediate base materials, and F2 is the flow pressure of the plasticized raw material.
